(19) United States
(12) Patent Application Publication
(10) Pub. No.: US 2003/0028579 A1
(43) Pub. Date: Feb. 6, 2003

(54) Process for component-based application development

(76) Inventors: Vinay Vasant Kulkarni, Pune (IN); Vilas Sadanand Prabhu, Pune (IN); Deepali Kholkar, Pune (IN)

Correspondence Address: CENTRAL COAST PATENT AGENCY, PO BOX 187, AROMAS, CA, 95004, US

(21) Appl. No.: 10/114,561

(22) Filed: Apr. 1, 2002

(30) Foreign Application Priority Data
Aug. 6, 2001 (IN) 759/MUM/2001

(51) Int. Cl. G06F 9/00

(52) U.S. Cl. 709/100; 717/101

(57) ABSTRACT

A hardware/software system for developing a software application by component modeling and instantiation is disclosed. The system has at minimum a computerized workstation with a GUI for enabling user control of system entities, a data repository for storing data particulars necessary for application development, a server application for providing data particulars and functionality required for component development, a processor for hosting the server application, and a modeling program accessible to the workstation and to the server application for design, construction, and testing application components. In a preferred embodiment, the application components are separately defined, built and tested using the modeling program and server functions wherein the coding required to generate and enable each application component from model information is automatically generated by the modeling program.

### FIELD OF THE INVENTION

The present invention is in the field of Software Development and pertains particularly to a process for component-based application development.

### CROSS-REFERENCE TO RELATED DOCUMENTS

This patent application case claims priority to Indian provisional patent application number 759/MUM/2001 filed on Aug. 6, 2001. The entire specification and drawings of Indian patent application number 759/MUM/2001 is incorporated herein by reference.

### BACKGROUND OF THE INVENTION

In the art of software development, developing large software applications is a daunting task. A software application generally has many separate but interacting parts that must be developed, integrated and tested for functionality in order to realize a working software application that is free of bugs. Component Based Software Development (CBSD) is a regimen that generally requires a software development team to coordinate independent module development efforts. Development and implementation assignments are usually distributed among and performed by members of development teams and sub-teams. For example, a sub-team could be devoted to component analysis while another is devoted to component testing and so on. Finished software components that have been successfully tested need to be integrated as working modules of the application that is hoped will be bug free when deployed and functioning as a whole.

A real challenge in software development of complex applications, such as business applications for example, is that there is no solid tool support in prior-art that enables sufficient automation of the development process or that can keep track of parallel operations on independent modules of the application that have been assigned to separate team members for development.

The development process as a whole can be visualized as a sequence of steps. Some of the development steps can be automated through use of special tools. However, most known component-based development methodologies provide only a textual description of the development process and mention (a possible set of) tools that one must “acquire” to facilitate the development process. The suggested tools often are not optimal for the circumstance requiring considerable effort to integrate the distinctly separate tool capabilities into an integrated and operational development process.

A viable software development exercise should be able to manage the following:

Domain of development such as hardware, software, workspaces, and the like.

Division of work into units that can be independently developed by a team with guarantees of integration.

Development of a work unit from one stage of software development to another.

Distribution of work between various developers within a work unit.

No prior-art system comes close to the type of support that is really needed and desired in CBSD technology. Anyone with considerable skill in the art will attest to the pitfalls and challenges that exist with prior-art processes. Therefore what is clearly needed is a process and apparatus for managing component-based software development that satisfies all of the above-mentioned goals.

### SUMMARY OF THE INVENTION

In a preferred embodiment of the present invention a hardware/software system for developing a software application by component modeling and instantiation is provided, the system comprising at least one computerized workstation having a graphic user interface associated therewith connected to the system for enabling user interaction with and manipulation of system entities, at least one data repository connected to the system for storing data particulars necessary for application development, at least one server application connected to the system for providing data particulars and functionality required for component development, at least one computerized processing machine connected to the system for hosting the at least one server application, and a modeling program accessible to the at least one computerized workstation and to the server applications for design, construction, and testing application components. The system is characterized in that the application components are separately defined, built and tested using the modeling program and server functions wherein the coding required to generate and enable each application component from model information is automatically generated by the modeling program as a result of ordered invocation of model instances of the application components.

In a preferred embodiment there are a number of computerized workstations each having a graphic user interface manned by a like number of users comprising a development team. Also in a preferred embodiment the data particulars necessary for application development include at least one persistent library of code. Further there may be a number of server applications dedicated to separate functionalities, and the functionalities may include repository server, source server, build server, and test server.

In another embodiment of the system the modeling program includes code generators and language processors that are invoked and operate in an automated fashion. Also the data particulars for component development may include modeling and coding workspaces. Each component may have its own workspace reserved for design and construction.

In another aspect of the invention a process for developing a software application through component-based modeling is provided, comprising the steps of (a) identifying the required application components of the application to be developed in terms of requirements for use and in terms of functionality expected; (b) designing and modeling the required components according to user expectations; (c) specifying the application logic for each modeled component; (d) generating code from each modeled component instance; (e) testing each component generated; and (f) deploying the successfully tested components as a finished application.

In preferred embodiments, in step (b), use-case diagrams are created for each component. Step (b) also may include creating a sequence diagram for every use-case diagram.

In some cases, in step (d), the code generation is automated through use of at least one code generator. Further, in step (e), testing may be performed automatically in a server. Still further, in step (f), deployment may be scheduled.

### BRIEF DESCRIPTION OF THE DRAWING FIGURES

FIG. 1 is a process diagram illustrating the basic steps of developing a complex software application according to an embodiment of the present invention.

FIG. 2 is a block diagram illustrating a model of an application development process according to an embodiment of the present invention.

FIG. 3 is a block diagram illustrating server domain and user/server interaction involved in application development according to an embodiment of the present invention.

FIG. 4 is a block diagram illustrating a realization (model 400) of a component workspace according to an embodiment of the present invention.

FIG. 5 is a chart illustrating a login and directory structure of coding workspace of a component according to an embodiment of the present invention.

FIG. 6 is a block diagram illustrating support for automating an application development process according to an embodiment of the present invention.

### DESCRIPTION OF THE PREFERRED EMBODIMENTS

As was described in the background section above, coordinating between members of a development team is largely ad-hoc. The inventor discloses a comprehensive process for coordinating and automating critical portions of development of a complex software system from beginning to end deployment. The methods and apparatus will be described in enabling detail in the description that follows.

In order to simplify understanding of the method of the invention, the inventor provides the following definitions and relationships. For purposes of definition, a component is defined herein as a logically coherent set of application functionality having high internal cohesion and low external coupling. A component owns some functionality and makes a portion or all of its functionality available to the external world through a component interface. This is especially true when taken in the context of distributed applications. For example, a component owns its own persistent data, which can only be modified through the component's interface. A component may however, under the definition provided herein, “depend” on another component's interface to implement its own interface. This dependant relationship between components helps to establish a user-supplier relationship among distributed components during application development.

An object model (OM) is a 3-tuple <CL, CM, OP> where CL is a set of class definitions, CM is a set of class methods, and OP is a set of global functions. A component (C) is equal to <I, O, D> where I is the interface of C, and O is the implementation of C, and D is a set of dependencies of C. I, O, and D are classified as object models.

An Interface is quantified as follows:

I, also termed Interface (C)=projection (O) where C is a component, and O is the implementation of the component (C). Projection is a function (F) which can be expressed as F: OM->OM. F is a selection of classes and operations. Class selection imparts selection of all member functions of that class. Projecting out a sub-set of a class in terms of data members and member functions is not possible. Associations are realized through functions (F), class methods (CM), or global operations (OP).

The interface of a component (I) is classified into an external interface (EXI) also expressed ExtInterface(C) and into an inter-component interface (ICI) also expressed ICInterface(C) where ExtInterface(C)=Projection₁(C) and ICInterface(C)=Projection₂(C). The relationship is such that Interface(C)=ExtInterface(C) ∪ ICInterface(C). The symbol ∪ denotes union.

If a component C interacts with k other components then ICInterface(C)=∪_{I=l,k}Icintf(C, Cₗ) where Where, Icintf(C, Cᵢ) denotes the subset of interface of C invoked by Cₗ.

A componet C is determined to be orthogonal if ExtInterface(C) ∩ ICInterface(C)=NULL where the symbol ∩ is intersection. O, defined above as an implementation of C is the functionality owned and implemented by C. O is also expressed herein as Own(C). D, defined above as a set of dependencies is also expressed herein as Dependency(C) and is equal to ∪_{I=l,k}Dep_{I}(C, C_{I}) where, Dep(C, C_{I})=Projection(Interface(C_{I})) and Dep(C, C_{I}) denotes the functionality implemented by C_{I} and used by C.

Assuming now that a software application for development has k components, then ∪_{I=l,k}Dependency_{I}(Ci)=Projection(∪_{I=l,k}Interface_{I}(Ci). For orthogonal components, Icintf(C, Cₗ)=Dep(C, Cᵢ). The reach of a component is defined herein as (R), also denoted as Reach(C)=Own(C)+∪_{I=l,k}Dep(C, Ci). The reach of a component describes the functionality that can be reached from the component and is defined as an object model.

The inventor has provided the set theoretic explanation above to show the required component properties and interaction characteristics under a convention of abstraction present during modeling of application components. The inventor utilizes a tri-level framework that is known by and available to the inventor for modeling components. The framework comprises a meta meta model structure at the highest abstraction level, a meta model, which is an instance of the meta meta model, and a user model, which is an instance of the meta model.

A software component can be thought of in the following ways:

As a versionable entity.

An application version is a configuration that is defined herein in terms of the applications' constituent component versions. A component version is a configuration that is defined in terms of its implementation version and its interface version.

As a development unit.

A dependency of a component, as previously described, identifies the functionality needed for the component's implementation, which is owned by another component or components. The component's ICI (defined above) encapsulates this dependency. In a preferred embodiment, ICI is organized as Icintf(C, Ci) to provide better control over change management and the development process as a whole rather than being organized as a monolithic entity. Icintf(C, Ci) defines dependence of component C on component Ci.

As a deployment unit.

A component can be deployed as a set of transaction processing (TP) servers, EJBean, CORBA objects, DLLs or as a set of COM objects. These deployment architectures and techniques are well known in the art.

It is the goal of the invention to model an application as a set of interactive components. In a preferred embodiment an application is viewed as a component dependency graph. In this view, a node on the graph identifies a single component with at least one edge incident on it, the edge incident belonging to another component (node) therefore identifying the dependence of the latter node to the former. In this logic a partial order as viewed over the span of the graph gives a conservative order for component development.

Consider the example:

Application={C1, C2, C3, C4, C5} where C=Component

Such that,

C2 depends on C1

C3 depends on C1

C4 depends on C2 and C3

C5 depends on C2 and C3

A dependency graph for the above example is provided below.

[image]

The partial order of development of components in the light of this dependency graph is: C1 followed by {C2 and C3} followed by {C4 and C5}.

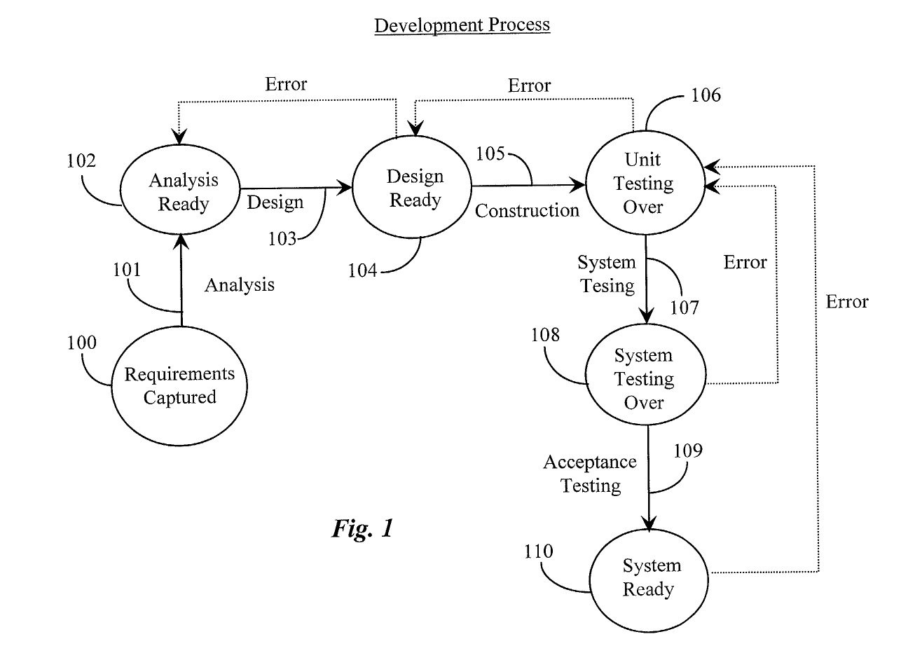

FIG. 1 is a process diagram illustrating the basic steps of developing a complex software application according to an embodiment of the present invention. As has been repeatedly described herein, an application is realized as a set of interacting components. A component implements logically coherent functionality. The interface of a component is the sole means of reaching its owned functionality. As has also been repeatedly described herein, a component owns persistent data that can be accessed only through its interface. In some aspects, a component may use the interface of some other component in order to implement its own interface.

In light of the relationship and parameters described above, components can be said to have a user-supplier relationship between them. The embodiment of FIG. 1 illustrates an abstract view of the development process of an application. At step 100 application requirements are captured or identified. The requirements are then analyzed as indicated by a directional arrow given the element number 101. At step 102, the analysis phase is complete and the analysis is ready. At this phase there are no error considerations. The analysis phase of application development as quantified herein by steps 101 and 102 of FIG. 1 involves several process steps considered sub-steps. For example, a first step involves identifying all of the envisioned components that make up the application and modeling them as a high-level package diagram along with assigning an analysis modeling team per component identified the teams responsible for the components modeling.

The advantage of modeling components independently and in parallel is that the entire process period is shortened while management and control is heightened or optimized. Part of the process of component modeling involves drawing a use-case diagram for every component the use-case diagrams identifying the expected system interactions of the application in terms of the associated component.

Each use-case diagram is analyzed in detail for the purpose of identifying variations, common-use issues, and any other scenarios of interest that may be useful in modeling. A sequence diagram is then produced for each scenario that is realized from the analysis of the use-case diagrams.

After preparing the sequence diagrams, a class diagram is drawn for each component. In this process, ownership of a class with a particular component is established. Established classes will be used by other components of the application sharing the class. After classes are created and identified in design, an inheritance hierarchy is established and refined across the application. Application domains representing the basic “types” for description of the application data are identified. Class attributes are also identified for each established class. Where appropriate, state transition diagrams are drawn for some of the classes. This process is likely to involve cross-functional integration. Finally, operations of classes are identified. Operations can be class methods or global operations. One with skill in the art will recognize that thorough analysis even though requiring many steps and sub-steps is important in facilitating a more error free and efficient design process.

The design process begins as indicated herein by a directional arrow labeled Design and given the element number 103. At step 104 the design of the application is ready and if there are any errors, they are fed back to step 102 to remedy the specific errors as indicated by a reverse arrow labeled Error emanating from step 104 and progressing back to step 102.

Like the analysis phase, the design phase comprises a plurality of steps and sub-steps. All of the object modeling takes place in the analysis and design phases. Firstly, classes whose state information needs to be preserved are identified. Such a class is called a persistent class. Primary access keys for persistent classes are then defined. Class operation signatures are defined in terms of the input and output parameters. Input and output parameters are defined as classes or domains. The interface of each component is defined in terms of its own classes and operations.

Dependencies of components to other components are formalized in terms of the component interface used to invoke the dependency. Through execution and run of a graphic user interface (GUI) prototype exercise, a user interaction paradigm is realized and classes that participate in GUI user interaction are identified through both external component interfaces and through inter-component interfaces for each GUI involved component.

Complex query operations are identified that involve multiple persistent classes and return multiple database rows possibly through cursor like behavior etc. Next, a physical database design is created. This includes mapping of entities such as class to table and how associations between two persistent classes are realized, in simple terms, whether a primary or foreign key will be used for accessing the particular entity.

After the preliminary design is complete as described above, several implementation strategies must be defined and implemented. Client-server communication protocols including transaction semantics need to be defined and formalized. Error handling and display of error data has to be defined and formalized. Memory management issues must be pinpointed and established.

Some challenges such, as impedance mismatch between object and relational entities must be addressed with appropriate schemas. Auditing and deletion operations of persistent objects are defined and established along with a paging strategy for large volumes of data. Optionally, a database distribution regiment is defined and established.

Implementation technology platforms are chosen such as a relational database platform, an online transaction-processing monitor (OLTP) if desired and a presentation manager. Once the development process is defined a team is organized to effectively release the application. It is noted herein that a modeling realization tool known to the inventor as MasterCraft™ provides adequate implementation support for all of the implementation strategies mentioned above. The program facilitates the development process and also provides automation to the development process. It further provides facilities for abstract modeling of specific complex queries.

A construction phase, illustrated by a directional arrow labeled Construction and given the element number 105 begins after the design phase is complete and design errors, if any, have been satisfactorily processed. Construction phase 105 is conducted using what are termed stubs by the inventor. A stub is a supplied function. A stub generally does not have validation checks or computations performed therein.

A function takes some input parameters, performs some computations involving the values of input parameters and returns a value.

For example,

A function that computes interest for an account for a stipulated period can be defined as,

Compute_interest (Integer account_number, Date from_date, Date to_date) :Float;

The above function can be invoked from another function as shown below:

Print_Account_details(Integer account_number)

{

Print account_number;

Print Compute_interest (account_number);

}

Thus, Print_account_details function depends on Compute_interest function and hence needs implementation of Compute_interest function for its own testing. This dependence can be mutual, that is function f( ) calls function g( ) which in turn calls function f( ). A stub implementation of a function is typically used in like cases. A stub implementation of a function simply returns a value of appropriate ‘type’ without performing the actual computations. For example, a stub implementation for Compute_interest function would be:

Compute_interest (Integer account_number, Date from_date, Date to_date) :Float

{

return 1.2;// Any value of type ‘float’

}

A stub simply provides mapping from an accepted set of input values to a set of expected output values. If functionality required by another component does not result in a change of state of component-owned data then the associated stub will be a pure function (accepting the input values and returning the expected output values). However, if functionality required by a component results in a change of state of data owned by another component then an additional stub is provided. This stub is “aware” of the change of state of data.

After all of the stubs are created, they are released into a common pool analogous to a library linked for access to every component for component implementation of the appropriate stub. Components are selected and implemented. That is to say that the component is completely implemented. Each component is unit tested in isolation from other components using the stubs. Unit testing is illustrated in this embodiment by a step given the element number 106 labeled unit testing over. Such unit testing is actually part of the construction phase and the testing is constrained to the functionality owned by the component including the server part, client part, and client-server integration.

Testing of the client portion of a component involves display behavior such as assuring that the appropriate controls are getting used; navigation behavior such as assuring that a navigation sequence is correct; and other behaviors such as assuring that inter-window communication ensues properly.

Testing the server portion of a component involves assuring the correctness of server functionality. Each unit operation that can be tested is tested in a standalone manner by providing a file-based construction mechanism to serve as its input parameters and a file-based storage mechanism to serve as its output parameters. No coding is necessary as a user need only enter values asked for in the format instructed. The provided infrastructure can also be extended for regression testing. Unit testing performed on all of the client-server operations of the components tests end-to-end functionality, basically connectivity, from GUI screen interface to database implementation. At step 106 then, the testing is considered over and any errors encountered during the testing of components are resolved by design phase 104.

After testing with stubs is complete and all errors are satisfactorily resolved, all of the stubs are replaced with actual implementation functions. In actual practice, this is a gradual transition. For example, upon complete implementation of any component, the stubs released by that component are then redundant. Replacing stubs for a component with real implementation functionality simply means using the necessary libraries for functionality instead of accessing the common pool of stubs. The unit testing of components (client, server, and end to end connectivity) is repeated until it is no longer necessary. That is to say that all application stubs are redundant. After unit-testing is complete or over, as noted in step 106, for each component that component is released for the next testing phase, which is referred to herein as a system test phase.

System testing is illustrated in this example by a directional arrow given the element number 107 and labeled System Testing. System testing means defining and enabling release of an application as a composition of components that have been successfully tested. System testing ensures completeness of any release so that it can be independently deployed. Part of the system testing involves binding the release to a server. In server binding, a distinct sever space is created for the release including a directory structure, files, and/or operating scripts. The code may include generated and hand-written code. If, for example, the well-known Windows™ OS is the deployment platform then compilation of client-side code of the release to a set of DLLs is undertaken. A client-server bridge is built between the platforms and end-to end testing is conducted. System testing ends at step 108 labeled System Testing Over. All errors encountered during system testing (107) are resolved back to step 106 for resolution as illustrated herein by a reverse-directional arrow labeled Error emanating from step 108 and progressing back to step 106. Step 108 is realized when all errors have been resolved satisfactorily.

After system testing is over as illustrated at step 108 in this example, acceptance testing begins as illustrated herein by a directional arrow given the element number 109 and labeled Acceptance Testing. It is noted herein that an application (set of interacting components) is developed from scratch over time using core components. These components are defined as those components with no or fewer dependencies on other components. The core components are incorporated first, and then functionality is built incrementally by adding new components and/or enhancing existing components.

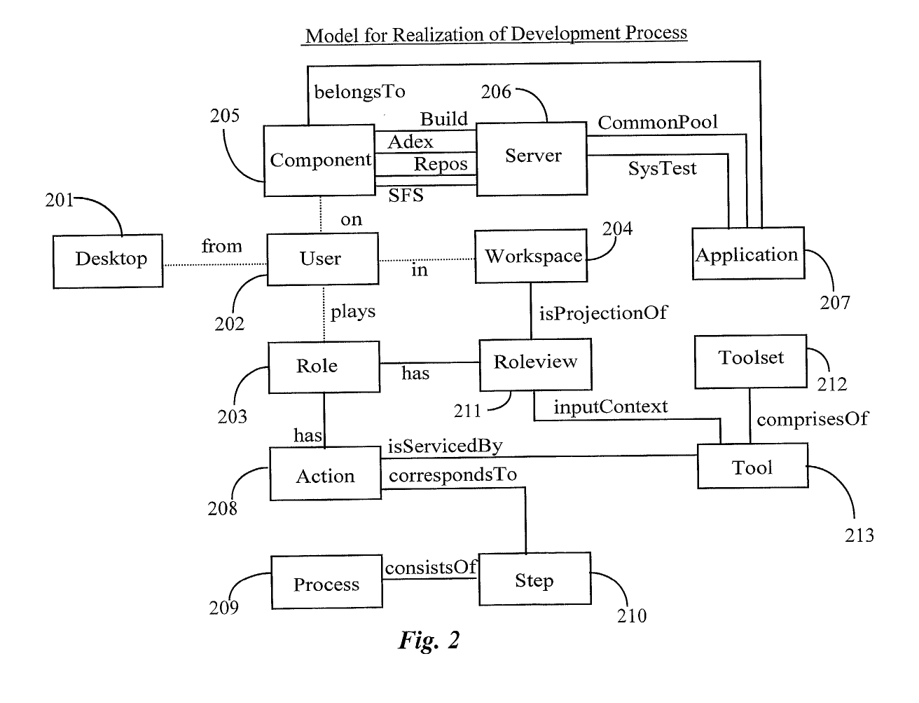

FIG. 2 is a block diagram illustrating a model of an application development process according to an embodiment of the present invention. The development process of an application is realized as an abstraction represented herein as a meta model. A beginning domain for application development is represented as a user desktop 201. A user is represented in this example as block 202 labeled User and associated with desktop 201 by an association line labeled From. A user performs in a workspace illustrated herein as workspace 204 connected to user 202 by an association line labeled in.

User 202 is working on a component represented herein as component 205 connected to user 202 by an association line labeled on for (working on). Component 205 belongs to an application illustrated herein as application 207 and connected to component 205 by an association line labeled Belongs To.

One with skill in the art of modeling will appreciate the abstract representation of this example. For example, the workspace attribute represents an abstraction for a plurality of workspaces such as component workspaces and special workspaces for sharing work-products between components including a protocol for component product sharing. Each component has its own workspace. The single abstraction component 205 represents all of the components of an application.

The protocol for sharing deliverables is realized in model. A supplier (component) puts its deliverables (model as well as code) in a space designated for sharing. All its users (dependant components) pick it up from the designated place as is convenient. Thus, parallelism in development is achieved at a component level with the responsibility of synchronization falling on individual components.

A server abstraction 206 is illustrated and connected to component 205 by a plurality of association lines labeled Build (Build Server), Adex (Adex Server), Repos (Repository Server), and SFS (Source File Server). In view of component 205, server 206 represents 4 different servers, and could represent more without departing from the spirit and scope of the invention. Server 206 is also associated to application 207 as illustrated herein by association lines labeled Common Pool and System Test. Therefore, in view of application 207, server 206 represents an abstraction for 2 servers, a common pool server (adapted to store and serve stubs), and a system test server adapted to perform system testing.

There may be more instances of server 206 that are shown in this abstract example without departing from the spirit and scope of the invention. In the case of build server or servers, that is where an application is built. A build server stores generated C++ code, compiled objects, libraries, and executables for unit testing along with appropriate test data. MasterCraft™ enables independent development and unit testing of application clients and application servers. OLTP monitor emulation is used in the build server for unit testing of server-side functionality. Moreover, the connectivity between an application client with application server running OLTP monitor is tested on a Unit Testing of Client to Server (UTCS) build server.

In the case of server 206 being an Adex server, all data generation on the sever is driven by the application model in Case Data Interchange Format CDIF format. A utility for exporting an application model in CDIF format and making it available to the build server is stored in the Adex server.

In the case of server 206 being a repository server then all application models created are stored therein along with MasterCraft™ models since MasterCraft is model driven. In the case of a source file server (SFS), all of the application source code is stored therein and served there from. Examples include QPP files and structured query language (SQL) files.

As a user interacts within the domain of the meta model of this example, the user creates and implements roles illustrated herein by an abstraction labeled Role and given the element number 203 and associated to user 202 by an association line labeled plays indicating user interaction. A role has a role view, or a “view for the role” as is illustrated herein by an abstraction labeled Role View and given the element number 211. Role view 211 is a projection of workspace 204 as is illustrated by an association line connecting workspace 204 to role view 211 labeled Is Projection Of. Role 203 also has an action illustrated herein by an abstraction labeled Action and given the element number 208. Action 208 is connected to role 203 by an association line labeled Has.

An abstraction representing a tool-set illustrated herein as a box labeled Toolset and given the element number 212. Toolset 212 is provided in this exemplary meta model, in a preferred example, to represent tools including MasterCraft™, which is a model driven tool known to the inventor.

Toolset 212 has tools illustrated as an abstraction labeled tool and given the element number 213. Tool 213 can represent any number of development tools. A user employs tool 213 input context of which comes from the role view 211. Action 208 is serviced by tool 213 as is indicated herein by an association line between action 208 and tool 213 labeled Is Serviced By.

Action 208 corresponds to a process step illustrated herein as an abstraction labeled Step and given the element number 210. A process illustrated herein as an abstraction 209 labeled Process consists of process steps 210 as is indicated herein by an association line labeled Consists Of placed between process 209 and step 210. An advantage to modeling the development process as a whole is that specific steps can be instantiated wherein the application code is automatically generated.

It will be apparent to one with skill in the art that a component, defined as a set of services is completely tested when all of its services are defined and tested. An example depiction of a service testing strategy is provided below.

MyService(A a): B; // Service takes class A as input and returns class B In order to test the functionality of “MyService” the following mechanisms are required:

A mechanism for specifying values for its input parameters.

A mechanism to construct the input parameters.

A main( ) function to invoke the service.

A mechanism to store its output parameters

A mechanism to specify expected output as reference

A mechanism to verify if the current output matches the expected output

The model illustrated in the example of FIG. 2 provides complete support for generation of all of the mechanisms listed above.

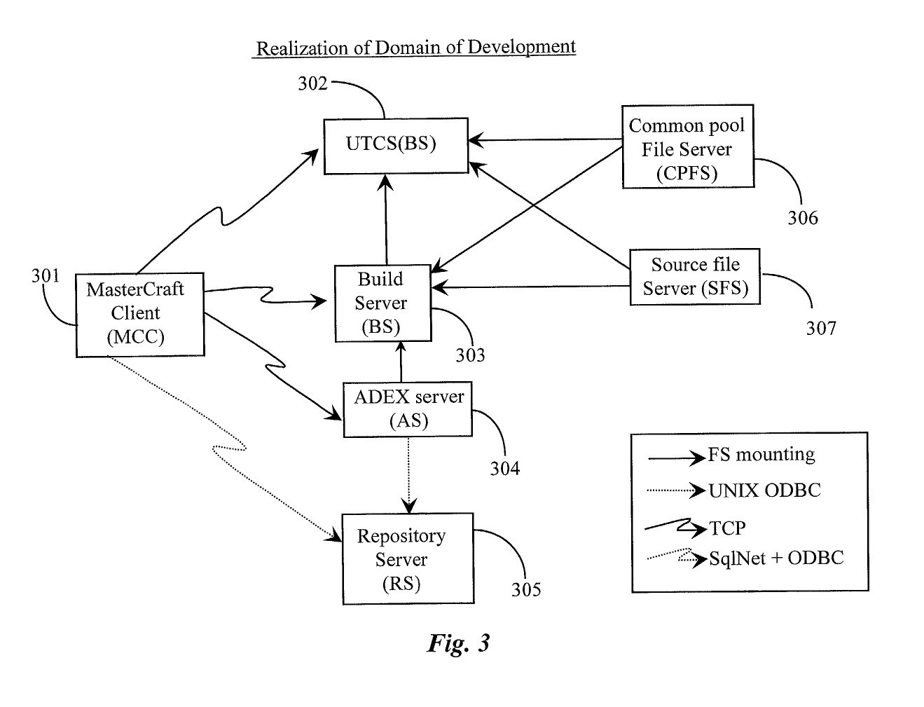

FIG. 3 is a block diagram illustrating server domain and user/server interaction involved in application development according to an embodiment of the present invention. Application developers interact with MasterCraft, which is an application-modeling tool that is known to the inventor, from a client machine illustrated herein as a box labeled MasterCraft Client (MCC) and given the element number 301. It is important to note herein that MCC 301 is an abstraction as realized in this example and not all client (user models) will be exactly the same. For example, some MasterCraft machines can be used to develop and test client-side application code while others may be set up for other tasks. All of the objects realized in this example are servers, some of which have already been mentioned above. In realizing server domain and interaction, client machine 301 interacts directly with several servers that will be re-described in this example. Also server to sever interaction is illustrated in this example.

A UTCS Build Server (BS) 302 is provided and adapted to enable “Unit Testing of Client to Server”. A user communicates from client 301 to server 302 using a telnet connectivity provider (TCP). A TCP protocol provides login capability for a user logging into server 302, for example, from the desktop of client machine 301. A legend is illustrated at the lower right side of this example of FIG. 3. The legend identifies and associates TCP with a specific type directional arrow placed between client 301 and server 302.

A build server (BS) 303 is provided separately from server 302 in this example. Server 303 is adapted for building the applications. Server 303 stores generated C++ code, compiled objects and code libraries, as well as executables for unit testing along with appropriate test data. In a preferred embodiment, TCP is the format used for server interaction between server 303 and client 301 as was described with reference to server 302 and as illustrated by the type directional arrow shown in between client 301 and server 303 and identified in the legend.

An Adex server (AS) 305 is provided in this example and is adapted for code generation. It is the mechanism for application code generation. An application model drives code generation on Adex server 304. In a preferred embodiment the application models exist in Case Data Interchange Format (CDIF). An export utility (not shown) stored on Adex server 304 is responsible for exporting application models in the appropriate CDIF format to any build servers that require the application model. MasterCraft client 301 interacts with Adex server 304 in TCP format as is the case with servers 303 and 302 and as identified by the directional arrow type placed between client 301 and server 304 and identified in legend.

It is noted herein that server 304 interacts with both servers 303 and 302 as illustrated herein by directional arrow identified in legend as file server File Server (FS) mounting. FS mounting occurs when a file system, for example FS1 of one networked computer, for example, computer 1 is “mounted” onto another networked computer, for example, computer 2. Computer 2 behaves as if FS1 is its own file system running on its own disk drive. A repository server (RS) 305 is illustrated in the model of this example and is adapted to store application models and MasterCraft development models.

A common pool file server (CPFS) 306 is provided and modeled in this example and is adapted to facilitate the user-supplier relationship amongst components of an application. For example, component functionality like generated C++ headers and a library is stored and made available from CPFS 306 in .a format. A dependent user component picks its functionality from the CPFS.

A source file server (SFS) 307 is illustrated within the model of this example and is adapted to store source application code like QPP and SQL files. Servers 306 and 307 serve information to servers 302 and 303 and also adapt an FS mounting format as indicated by directional arrows identified in the legend at lower right. Ability to realize the domain of application development along with provision of a modeling tool such as MasterCraft allows parallel development and testing of many components of an application such that there are no ad hoc development procedures or chance of undetected human error. Versioning, and integration as well as final testing and deployment environments are well controlled through the generative modeling approach to the application development process.

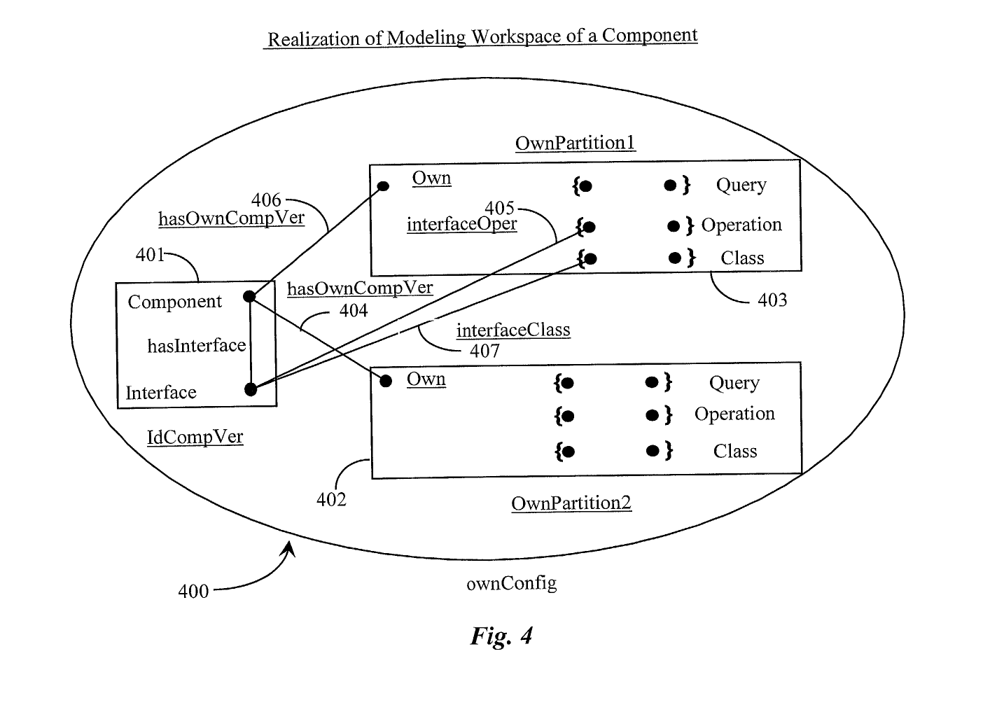

FIG. 4 is a block diagram illustrating a realization (model 400) of a component workspace according to an embodiment of the present invention. Model 400 is realized uniquely for each separate component being developed for an application. That is to say the each separate component has its own workspace. Workspace encompasses component static behavior (model) and component dynamic behavior (code). Therefore, a workspace of a component has a modeling workspace as well as a coding workspace. Each component has an independent workspace as was described above. Model 400 illustrates an exemplary modeling workspace of a single component.

Modeling workspace 400 of a component can be viewed as a set of containers. An application is a set of components and it is essential to be able to distinguish which set of containers stores model information of which component. Most-often information containers are named according to which model they belong to. This is a relatively naive way of setting distinction between containers. A better solution represented in this example is to classify the containers into different “kinds” wherein a ‘kind’ defines the contents of a container. For example, a container of “own” kind contains model information owned by the component. A container of “semantic” kind identifies a related set of “own” containers for a component. This ‘type’ based distinction is a more generic and sound way of classification and organization of component models.

Referring now back to FIG. 4, a semantic partition 401 of workspace 400 is illustrated herein and labeled idCompVer. Semantic partition 401 has a component object (labeled Component) and a component interface (labeled Interface) within the domain of idCompVer. An association line labeled hasInterface associates Component with Interface inside partition 401.

Model 400 also has a set of OwnPartitions identified by semantic partition 401. These are illustrated herein as OwnPartition 1 also given the element number 402, and OwnPartition 2 also given the element number 403. It is noted that there may be more than two OwnPartitions in workspace model 400 without departing from the spirit and scope of the present invention. The inventor deems that two such partitions illustrated herein are sufficient for the purpose of explanation. OwnPartition 402 is associasted to semantic partition 401 by an association line labeled hasOwnCompVer (has own component version) and given the element number 406. OwnPartition 403 is associated with semantic partition 401 by an association line labeled hasOwnCompVer and given the element number 404.

Each OwnPartition within model 400 contains owned model of a component represented logically herein by a bracketed Dot-array labeled Query, Operation and Class. An interface represents class operations or methods. Therefore, associations are drawn between Interface of semantic model 401 and one or more of class and operation. Each OwnPartition of semantic model 401 has a class and one or more operations that define an Interface as illustrated within partition 401. An association is drawn between the Interface of model 401 to the “operation set” and “class” of an Owned model. These associations are illustrated herein from Interface in model 401 to operation in QwnPartition 1 by an association line labeled interfaceOper (interface operation) and given the element number 405, and by an association line labeled interface Class and given the element number 407.

As can be seen in this example, model 400 is a configuration containing semantic as well as own partitions (containers) of a component. A repository user, not illustrated in this example, owns the configuration of model 400 and has permission to write or generate code in the workspace as it relates to own partitions. Modeling workspace adheres to model (static behavior) while coding workspace adheres to dynamic behavior. An example of coding workspace is presented below.

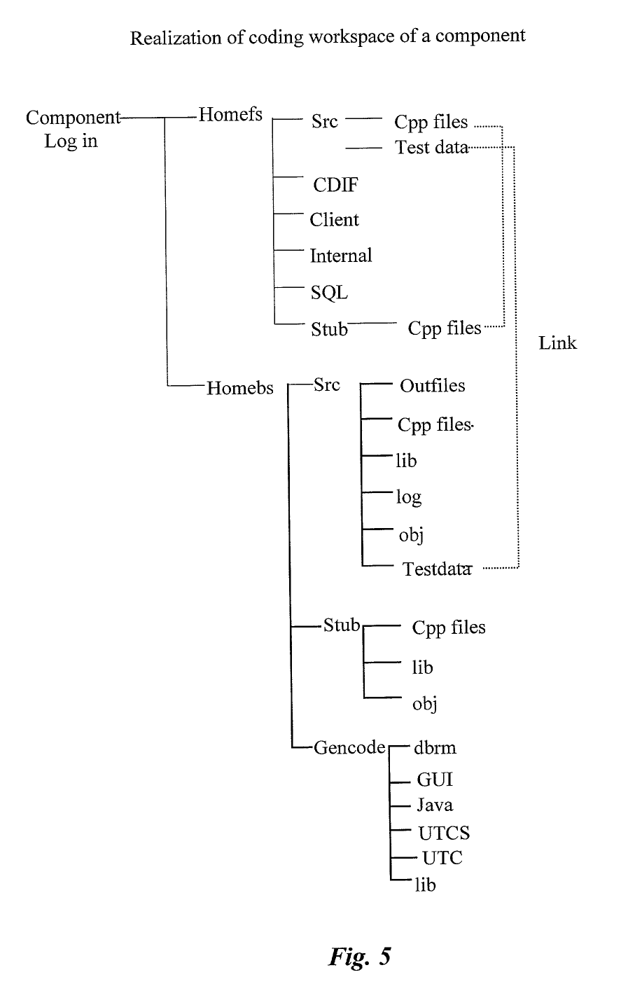

FIG. 5 is a chart illustrating a login and directory structure of coding workspace of a component according to an embodiment of the present invention. Firstly a login procedure is performed by an accessing component represented as a starting point labeled Component Login.

The directory structure, which is a file system, is hierarchical and self-explanatory. One with skill in the art will understand the directory structure illustrated herein. The entire structure has two jump-off points after login in successful. These are labeled Homefs and Homebs. These points of the directory are at the same hierarchical level. Homefs sub-directory, meaning those items under Homefs, has all of the component specifications identified therein. Source (Src), CDIF, Client, Internal, SQL, Stub, Cpp, and test-data files are found under the heading Homefs. It is noted herein that the Stub/Cpp file directory point and the Src/Cpp directory are linked for convenience.

Homebs sub-directory, meaning those items listed under Homebs, contains all of the generated code, object code, and user libraries. Also generated test-data templates, and other executables for unit testing including output unit testing are in the sub-directory of Homebs. Under Src, for example, are Outfiles, Cpp files, Libraries (lib) Log files, obj files, and test data files. It is noted herein that the sub-directory points of Homebs/Src/Test-data and Homefs/Src/Test-data are linked together for convenience. Under the sub-directory Homebs/Stub are Cpp files, lib files and ojb files. Under the sub-directory Homebs/Gencode are dbrm files, GUI files, Java files, UTC and UTCS files, and lib files.

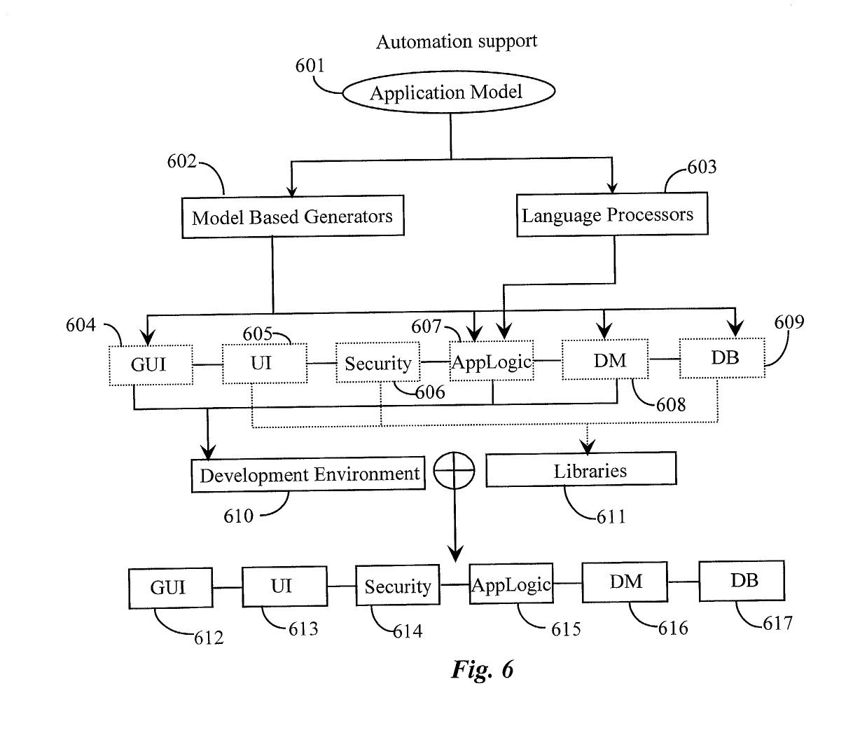

FIG. 6 is a block diagram illustrating support for automating an application development process according to an embodiment of the present invention. The block example illustrated herein represents the automation of development from the point of instantiation of an application model illustrated herein as application model 601 to a completely generated and tested application ready for deployment. Application model 601 is the collective modeling of all application components in terms of functionality and expectation from the outside world. This is the model-based generative approach described further above in this specification. Instantiation of the model(s) that comprise the application model initiates automated development of a real working application. At the first level of implementation, there are model-based generators 602 and language processors 603. One with skill in the art will recognize these modules (602,603) to be active functions, which are automated once the application model is instantiated and these functions are called.

There are several distinct layers and functionalities in this model architecture. The entire structure of this example can be thought of as separated layers of the process beginning at the top and working down to the bottom of the structure. Loosely speaking, the topmost layer represents the application model. The layer below it represents model-based code generation wherein the results are fed into a generic model-based application architecture, which is represented by a lower row of modeled components (dotted rectangles). The following layer of architecture represents compilation, building, and packaging of generated code into a real software application that is ready to be deployed with support of runtime libraries linked to the “working” application.

Model-based generators 602 and language processors 603 generate code from model and specification languages into a distributed architecture shown by a row of dotted rectangles.

A graphical user interface GUI 604 (dotted rectangle) is predominately a presentation layer that also facilitates local database access. A database under development is represented in this example by a dotted rectangle labeled DB and given the element number 609. In a preferred embodiment, database 609 is a relational database management system (RDBMS) DB 609 is considered an architectural software layer in this example. Other types of databases may also be used in place of a RDBMS in this example; therefore database 609 should not be construed in terms of type to be limited to a RDBMS. A user interface (UI) 605 is illustrated as a dotted rectangle adjacent and to the right of GUI 604. UI 605 is a separate software layer and has a C++ interface with the GUI presentation layer 604. UI 605 is responsible for managing connectivity between application client modules and application server modules using primitives of middleware of choice such as the well-known OLTP monitors Tuxedo™ and CICS6000.

A security layer is represented in this example by an illustrated rectangle labeled Security and given the element number 606. Security layer 606 is responsible for performing data encryption and data decryption as well as DB access control. An application logic layer represented herein by a dotted rectangle labeled Applogic and given the element number 607 is the layer that represents business functionality. A database management layer is illustrated in this embodiment by a dotted rectangle

A data management (DM) layer 608 provides an object-oriented view of what is stored in DB 609. Standard methods like Create, Get, Update, Delete that exist for every persistent class and all Query methods are defined and developed in the DM layer. DM 608 is the interface between DB 609 (relational, inherently flat) and Applogic layer 607 (object-oriented, hierachal). Layers 604-609 represent all of the functional components of application model 601 being developed. Model-based code that has been generated at the level of generators 602 and code generated from specification languages by processors 603 is input into developing components.

GUI layer 604, Applogic layer 607, DM 608, and DB 609 all receive model-based code that is automatically generated for each component under development. Applogic layer 607 receives code generated from specification languages by processors 603. It is noted herein that the elements UI layer 605, Security layer 606, and database layer 609 are all linked by an illustrated dotted line. Code automatically generated for these architectural layers is compiled to a set of runtime libraries to be linked with a finished and deployed application.. The libraries just mentioned are illustrated in this example by a solid rectangle labeled Libraries and given the element number 611 situated in a row just beneath the developing component layers.

Generated code from modeled components of the application being developed is used to generate a complete application in a development environment illustrated herein as a solid rectangle labeled Development Environment and given the element number 610. Application development capabilities of environment 610 leverage the generated code (generic to the modeled components above) in order to build a software application that links to runtime libraries 611. The cooperation between the development environment 610 and libraries 611 to build and support a completed software application is illustrated by the symbol placed between the two just-mentioned elements. The complete application that is tested and ready for deployment is represented as the bottom row (solid boxes below) of this application development architecture.

Actual working application components illustrated herein are GUI 612, UI 613, Security layer 614, application logic layer 615, data management layer 616, and database 617. All of these finished components are fully integrated and deployable. They have been tested and collectively represent the generated application. Although not shown in this example, there are services for updating the application and for querying the database. The update service is known to the inventor as “BT” and necessarily changes the state of an application such as, perhaps, updating the database of the application. The second mentioned service is known to the inventor as “ET” and is used for querying the application database. ET does not change the state of an application.

It will be apparent to one with skill in the art that the process of developing a complete software application from modeling components can be made much simpler and more reliable by using the model-based approach described in this specification. The process of the invention can be performed on a wide variety of platform mixes and can use a wide variety of modeling languages. Therefore the methods and apparatus of the invention should be afforded the broadest possible scope under examination. The spirit and scope of the invention should be limited only by the claims that follow.

What is claimed is:

1. A hardware/software system for developing a software application by component modeling and instantiation comprising:
at least one computerized workstation having a graphic user interface associated therewith connected to the system for enabling user interaction with and manipulation of system entities;
at least one data repository connected to the system for storing data particulars necessary for application development;
at least one server application connected to the system for providing data particulars and functionality required for component development;
at least one computerized processing machine connected to the system for hosting the at least one server application; and
a modeling program accessible to the at least one computerized workstation and to the server applications for design, construction, and testing application components;
characterized in that the application components are separately defined, built and tested using the modeling program and server functions wherein the coding required to generate and enable each application component from model information is automatically generated by the modeling program as a result of ordered invocation of model instances of the application components.

2. The system of claim 1 wherein there are a number of computerized workstations each having a graphic user interface manned by a like number of users comprising a development team.

3. The system of claim 1 wherein the data particulars necessary for application development include at least one persistent library of code.

4. The system of claim 1 wherein there are a number of server applications dedicated to separate functionalities.

5. The system of claim 4 wherein the functionalities include repository server, source server, build server, and test server.

6. The system of claim 1 wherein the modeling program includes code generators and language processors that are invoked and operate in an automated fashion.

7. The system of claim 1 wherein the data particulars for component development include modeling and coding workspaces.

8. The system of claim 1 wherein each component has it's own workspace reserved for design and construction.

9. A process for developing a software application through component-based modeling comprising steps of:
(a) identifying the required application components of the application to be developed in terms of requirements for use and in terms of functionality expected;
(b) designing and modeling the required components according to user expectations;
(c) specifying the application logic for each modeled component;
(d) generating code defining a component from each modeled component instance;
(e) testing each component generated; and
(f) deploying the successfully tested components as a finished application.

10. The method of claim 9 wherein in step (b), use-case diagrams are created for each component.

11. The method of claim 9 wherein step (b) also includes creating a sequence diagram for every use-case diagram.

12. The method of claim 9 wherein in step (d) the code generation is automated through use of at least one code generator.

13. The method of claim 9 wherein in step (e) testing is performed automatically in a server.

14. The method of claim 9 wherein in step (f) deployment is scheduled.
